(19) United States
(12) Patent Application Publication
(10) Pub. No.: US 2019/0267199 A1
(43) Pub. Date: Aug. 29, 2019

(54) DISCONNECT SWITCH BLADE ELECTRONIC INFORMATION SENSOR SYSTEM FOR DETECTING BLADE PERFORMANCE AND FOR ENSURING PROPER BLADE CLOSURE

(71) Applicant: CLEAVELAND/PRICE INC., TRAFFORD, PA (US)

(72) Inventors: JONATHAN LEWIS, WEST NEWTON, PA (US); ALEXANDER UDANIS, TARENTUM, PA (US); ANGELO ROMETO, NORTH HUNTINGDON, PA (US); JUSTIN T. REINHART, IRWIN, PA (US)

(73) Assignee: CLEAVELAND/PRICE INC., TRAFFORD, PA (US)

(21) Appl. No.: 16/174,761

(22) Filed: Oct. 30, 2018

Related U.S. Application Data
(60) Provisional application No. 62/634,468, filed on Feb. 23, 2018.

(51) Int. Cl. H01H 11/00; H01H 9/16; G08B 21/18; G05B 19/042; G06F 7/02

(52) U.S. Cl. CPC H01H 11/0062; H01H 9/161; H01H 9/168; H01H 31/28; G05B 19/042; G06F 7/02; H01H 2011/0068; G08B 21/182

(57) ABSTRACT

A disconnect switch blade electronic sensor assembly system for a disconnect switch including a sensor assembly directly attachable to a switch blade for detecting the switch blade position, acceleration vectors and angular velocity of the switch blade relative to a cooperating disconnect switch stationary break-jaw contact assembly using a self-contained array of on board sensors for detection to ensure that the switch blade is in full electrical and mechanical contact with the stationary contact assembly in a switch fully closed position switch and fully out of electrical and mechanical contact with the stationary contact assembly in a switch fully open position. The switch blade sensor assembly can include a visual indication component to provide visual indication on the sensor assembly of switch status relative to the break-jaw assembly which can be seen on the ground or may initiate a remote visual or other indication of such switch status.

### CROSS-REFERENCE TO RELATED APPLICATION

This is application claims the benefit of U.S. Provisional Application No. 62/634,468 filed Feb. 23, 2018 which is incorporated herein by reference in its entirety as though fully set forth.

### BACKGROUND OF THE INVENTION

The invention relates generally to a sensor assembly system for a high voltage disconnect switch and, more particularly, to a sensor assembly for detecting the position, speed, acceleration, temperature, and/or current of an attached disconnect switch blade for the purpose of ensuring that the switch blade has closed properly into its corresponding parting contacts, that the switch blade is closing with proper speed, and not operating at relatively high temperature due to poor contact engagement.

In electric power systems, disconnect switches are employed to isolate lines and apparatus to permit the inspection or repair of such apparatus or redirect power or other reasons. An example of such a disconnect switch, is a high voltage vertical break disconnect switch. This type of high voltage disconnect switch typically has a relatively long and somewhat flexible switch blade that is prone to suffer from wear, from improper installation, from weathering or from improper or incomplete operation, e.g. from ice build-up on the break jaws. This may cause the switch blade to not fully seat in its parting contacts, i.e., break jaws, making it unable to carry its rated current and causing damage to the parting contacts from overheating. From ground level, a utility operator may not be able to see whether proper closure of the disconnect switch has occurred, i.e., with full seating of a switch blade contact portion within the oppositely disposed break jaw contacts. Remote closure by a motor operator offers no ability to review the correctness of the switch closure before energization.

As a result, there has been a long-felt need in the electric utility industry that uses such high voltage disconnect switches—for analytics, verification, and status directly from a switch blade to be able to confirm proper operation. In this regard it has also been a long-felt need to determine if a subject high voltage disconnect switch is operating within desired specifications such as operating speed, temperature, and complete closure.

Some recently issued patents have dealt with this problem, such as U.S. Pat. No. 9,041,402 B2 by Patrick Lalonge, et al., issued May 26, 2015, and assigned to EHT International Inc. The Lalonge patent discloses a method for detecting an abnormality or malfunction of a switch in a high voltage electrical substation. The method comprises determining a position of an arm of the high voltage disconnect switch operatively connected to a motor. The motor is operated driving the arm of the high voltage disconnect switch. The torque of the motor, at a position, is determined for given position of the arm. The torque of the motor is compared to a predetermined torque threshold for the current position of the arm. An abnormal operation is determined based on the comparison. An apparatus for determining a malfunction of an arm of a disconnect switch is also disclosed which includes a memory and a torque comparison unit. A system for determining a malfunction of an arm of a disconnect switch is also disclosed comprising a position sensor, a torque determining module for determining a torque of the motor when the arm is at the current position, and an abnormality detecting module connected to the position sensor and torque determining module that compares the torque of the motor to a torque threshold previously associated with the current position of the arm to obtain a comparison result.

U.S. Pat. No. 9,052,363 B2 by Joseph R. Rostron, et al., issued Jun. 9, 2015, and assigned to Southern States LLC, discloses a high voltage switch blade closing detector and method. The Rostron patent discloses a blade closing detector and an electronic or visual indicator. In one embodiment one type of detector is disclosed using a gravity switch and a magnetic pickup to detect proper engagement between the blade and the switch. A second embodiment discloses a second type of detector using a sliding latch with a visual indicator rod to provide a visual indication of proper engagement of the blade within the jaws. A third embodiment discloses a detector using a magnetic switch with a pivot arm and a dome shaped visual indicator. The Rostron patent discloses that the detector may be used individually or in combination and may be augmented with communication equipment to transmit switch status to a remote location. The Rostron patent discloses the blade closing detector includes a first detector component having a first indicator actuation element carried by the blade arm, and a second detector component having a second indicator actuation element located near the jaws. The first and second detector components are positioned to cause the first indicator actuation element to become positioned adjacent to the second indicator actuation element when the blade is properly engaged in the jaws. Also, the first and second indicator actuation elements have an indication sensitivity causing an indicator actuation to be caused by the first and second indicator actuation elements when the blade arm comes into proper physical engagement with the jaws and no indication sensitivity when there is no such proper physical engagement. A visual indicator is disclosed which provides a visual distinction between a detector to show detector actuation versus no detector actuation.

Another such invention is disclosed in U.S. Pat. No. 9,071,110 B2 by Patrick Lalonge, et al, issued Jun. 30, 2015, and assigned to Energie H. T. International Inc. The Lahonge patent discloses a system and method for detecting an abnormal operation of a motor controlling an operating parameter of a machine. Both a torque of the motor and the operating parameter are monitored. A memory stores a plurality of predetermined torque values indicative of a normal operation of the motor. A plurality of operating parameter values are also stored in the memory with each operating parameter value having a corresponding predetermined torque value associated therewith. The predetermined torque value corresponding to the monitored operating parameter is retrieved from the memory and compared to the monitored torque value to detect abnormal operation of the motor.

In U.S. Pat. No. 9,666,393 B1 by Peter M. Kowalik, et al., issued May 30, 2017, and assigned to Cleaveland/Price Inc., the present assignee is disclosed a high voltage disconnect switch with a blade position detector and rollover indicator. The blade position and rollover indicator is operatively attached to an elongated movable switch-blade assembly of a horizontally mounted high voltage vertical break disconnect switch. The blade position detector and rollover indicator is gravity responsive and attached in predetermined position to the elongated disconnect blade assembly that reacts when the proper angle of closure of the blade is obtained in an intermediate closed switch position and finally when the proper angle of blade rollover is obtained in a fully closed switch position to provide in one embodiment a visual indication of full closure of the disconnect switch. The aforesaid U.S. Pat. No. 9,666,393 B1, by Peter M. Kowalik, et al., which is assigned to the present assignee, is herein incorporated by reference in its entirety as though fully set forth.

It is therefore an object of the present invention to devise a high voltage disconnect switch blade sensor assembly and system therefor that is simple to install on a high voltage switch blade and provides reliable analytics, verification, and status directly from the switch blade that confirms proper switch operation and this information is electronically displayed locally and transmitted by radio or optical fiber.

### SUMMARY OF THE INVENTION

The present invention provides an improved and efficient sensor assembly system for detecting the proper closure of a high voltage disconnect switch blade within its parting contacts, and to ensure that the switch blade is closing with proper speed, and that the switch blade is not operating at excessively high temperature due to poor switch contact engagement. The present invention provides analytics, verification, and status from a sensor assembly attached to and carried only by the switch blade. It confirms proper operation of the disconnect switch without the use of a magnetic sensor and without sensing motor torque of an associated switch motor operator or requiring some other switch motor operator characteristic, while only requiring a single sensor assembly contained in a housing attached directly to the switch blade. The sensor assembly includes a self-contained sensor array including a number of sensors which are electronic or electromechanical. The self-contained sensor array preferably is miniaturized so that the sensors are microelectronic or microelectromechanical types. The sensors may be combined into what is known as a “System On Chip”. No other sensor components detached from the switch blade are required to sense switch operation. The sensor assembly of the present invention may be installed at the factory before shipment on the switch blade or is suitable to a retrofit installation in the field on an existing switch blade.

The high voltage disconnect switch blade sensor assembly of the present invention provides an electric utility operator the information necessary to ensure proper operation of a high voltage disconnect switch. Such a switch can operate between voltages such as 5 kV to 765 kV and carry currents from 600 amps to 5000 amps. Such a switch is employed to isolate lines and apparatus to permit the inspection or repair of such apparatus or redirect power or other reasons. The sensor assembly determines if the high voltage disconnect switch is operating within desired specifications. The sensor assembly can determine if the switch is moving at the expected rate, i.e., speed and/or acceleration and/or is in the proper position and/or is operating within a proper temperature range. If the switch is not moving at the expected rate or is not in the proper position or is operating beyond the proper temperature range or doesn't close properly, the sensor assembly will alert an operator, either by visual electronic notification or by transmission of electronic data back to a central network. It can also inform the operator that these sensed variables are within a normal range. The information is in six (6) forms, i.e., proper switch operation duration, proper switch blade travel, proper switch blade speed of operation, switch blade unexpected motion or acceleration during an operation, switch blade current, and switch blade temperature. This data that the sensor assembly provides ensures that the switch is operating within design specifications, which is an observation that is difficult from ground level.

The disconnect switch blade sensor assembly of the present invention is an electronic device that monitors position and operation of a disconnect switch blade. Due to the typical location of a human operator in relationship to the blade of the switch, it can be difficult or impossible to ensure that the switch is functioning properly. The present invention provides the human operator of the switch and/or SCADA (abbreviation for Supervisory Control and Data Acquisition Network) a clear confirmation the switch is operating properly.

The sensor assembly of the present invention, as mentioned, is contained in a housing that attaches directly to the blade of the switch—it can monitor proper switch operation duration, proper switch blade travel, proper switch blade speed of the operation, switch blade unexpected motion or acceleration during an operation, switch blade current, and switch blade temperature to determine if there are any issues with the switch's operation. Additionally, it detects in order to insure that the switch blade is properly seated into its pressure contacts for full switch closure and full electrical current carrying capability. The sensor assembly may be comprised of a plastic housing, power supply, self-contained sensor array, microcontroller, visual indicator, and a radio module. The components of the sensor assembly work together to obtain the status of the switch; and can relay the information back down to a ground-based transceiver that is connected to a SCADA system or substation and/or visually to the human switch operator on the ground via indicating lights.

The housing of the sensor assembly is preferably weather-sealed and may be made of a UV-resistant plastic, such as, UV stabilized high density polyethylene, referred to herein subsequently as HDPE. The housing desirably has a cavity on the back thereof to securely mount it to a switch blade. It may be mounted to the switch blade using two worm drive hose clamps. There are slots provided in the plastic housing for the clamps to pass through. An insulative material is used between the housing of the sensor assembly and the blade of the switch to minimize heat transfer from a hot switch blade. The sensor assembly is “calibrated”, once properly installed, by logging the initial position, speed, and acceleration characteristics of the switch blade. From this point the sensor assembly compares the operational characteristics to the initial calibration; if the operational characteristics of the switch are within a predetermined threshold the sensor assembly indicates proper operation of the switch.

As mentioned, it is difficult for a human electric utility operator to determine if a switch is operating properly, or if it's closing fully, from observing the switch at ground level. The sensor system assembly of the present invention determines if the switch is operating properly, by determining if the switch is moving at the expected rate, and can detect if the switch blade is properly seated into its pressure contacts, by monitoring the final position of the switch blade. Improper or unexpected movement of the switch detected by the sensor assembly can indicate excessive wear and tear on the equipment or tampering.

The sensor assembly of the present invention comprises several electrical components that work together. They include a power supply that may contain a battery, a solar panel, an inductive power supply, or some combination of them. The sensor assembly also includes a high-efficiency voltage regulation circuit, that provides a stable voltage to the internal electronics. The sensor assembly also includes a self-contained sensor array which may comprise a gyroscope, accelerometer, magnetometer, ultrasonic transducers, time-of-flight light sensors such as LIDAR (abbreviation for Laser Imaging, Detection and Ranging), cameras (for detecting position, motion, corona, or arcing), current sensors, (such as Rogowski coils, current transformers, or hall-effect sensors), environmental sensors, such as humidity, or barometric pressure sensors, and/or temperature sensors. The sensor array obtains data from the operational characteristics of the switch. These sensor assembly components measure the angular and rotational position and temperature of the blade of the switch blade. An on-board microcontroller is also included in the sensor assembly that reads the data from the sensors periodically and determines if the present operational characteristics of the switch are similar to those of a properly adjusted and functioning switch. The microcontroller can control daylight viewable indicator lights, such as red and green LED's, to indicate open and close status respectively of the switch. Also the sensor assembly may include a radio transceiver to transmit the information of the switch down to a ground based transceiver.

The microcontroller will process and prepare data from the sensor array for actuating on-board visual indicators and/or transmitting to the ground based transceiver. The sensor assembly processes the data and compares it to previously obtained reference data. The sensor data can be transmitted wirelessly to another remote device to process and aggregate the data. This data processing device is referred to as a ground based transceiver data processing device. The microcontroller in the sensor assembly will process and can packetize the data for transmitting by radio to the ground based transceiver data processing device. The ground based transceiver radio module provides a link to a SCADA system for transmitting information to a utility control room. The ground based transceiver data processing device may reduce the power and computational requirements of the sensor assembly, and aggregate sensor readings to diagnose trends. This serves to improve the reference data and operational characteristics among a population of switches. Based on the data collected by the ground based transceiver data processing device, it can provide local indication or transmit data back to a control room.

The power supply of the sensor assembly is maintained at high potential, i.e., high voltage, such as 115 kV. The “ground” of the electronics is at a high potential, such as 115 kV, compared to true/earth ground. This eliminates safety concerns and bulky insulated cables to true ground. Comparable products such as used in consumer electronics and the automotive industry rely on a power supply at true/earth ground potential, or are purely mechanical in nature.

Data processing through the use of a microcontroller or digital signal processor is not novel in and of itself. However, the analytics performed on blade positioning and movement by use of the sensor assembly of the present invention and the operation of the sensor assembly in collecting blade data to be processed by the sensor assembly microcontroller and/or the ground based transceiver microcontroller provides for a unique approach.

Indications of an open or closed switch are fairly common in the electric utility industry. An electronic indication maintained at actual line potential, based on the movement and positioning of the switch itself, is unique. Other prior art electronic switch position sensors such as that disclosed in the previously mentioned U.S. Pat. No. 9,041,402 B2 by Patrick Lalonge, et al., and assigned to EHT International Inc. rely on the positioning of the torsional pipe of the switch to determine information about the status and health of a switch, unlike the present invention which obtains formation from the switch blade itself which is more accurate. The previously mentioned U.S. Pat. No. 9,052,363 B2 by Joseph R. Rostron, et al. utilizes a detector mounted to the moving switch blade that reacts with another detector mounted to the jaw of the switch, and the two detectors when close to each other provide an indication of a properly closed switch. Conversely the present invention utilizes a novel method for indicating a properly closed switch via sophisticated accelerometers and other sensors mounted to the switch blade that indicates the position of the switch blade without the necessity of a second detector or detector component mounted to the jaw or any other part of the switch. This and other distinguishing features will be pointed out.

Radio systems maintained at high potential are common. The data being transmitted at that high potential by the sensor assembly of the present invention is also believed novel.

Ground level data processing units are very common, especially when connected to lower-powered devices. The ground based transceiver data processing unit of the present invention is believed novel based on the nature of its algorithms for indicating system health and operating parameters.

The sensor assembly of the present invention may incorporate the following additional features:

a. an industrial temperature sensor, to indicate the switch's operating temperature;

b. a current sensor, magnetically coupled to the switch or otherwise, to determine current flowing through the switch;

c. a calibration method for the sensor assembly, incorporating a push-button, radio command, or other external signal to the sensor assembly; and,

d. a sensor to monitor environmental information, such as humidity and/or barometric pressure.

The sensor assembly does not need to possess both a radio and local indication lights to fulfil its primary function.

The present invention as mentioned determines position data based on blade position rather than switch motor operator position. This provides the advantage of more accurately indicating proper operation and closure when compared to the previously described arrangement in U.S. Pat. No. 9,041,402 B2 by Patrick Lalonge, et al., and assigned to EHT International Inc. which monitors just the linkage system. The sensor assembly of the present invention as mentioned resides at line potential, and can be attached to any switch—whether automated through a motor operator or otherwise or manually operated.

These and other aspects of the present invention will be further understood from the entirety of the description, drawings and claims.

### BRIEF DESCRIPTION OF THE DRAWINGS

For a better understanding of the invention reference may be made to the accompanying drawings exemplary of the invention, in which:

FIG. 1A is a block diagram of the sensor assembly;

FIG. 1B is a block diagram of a ground level data processing unit in operative radio communication with the sensor assembly shown in FIG. 1A;

FIG. 2 is a schematic diagram of the system of the present invention for detecting abnormal operation;

FIG. 3A is a plan view of the sensory assembly mounted on a switch blade;

FIG. 3B is an end view of the sensory assembly mounted on a switch blade shown in FIG. 3A;

FIG. 3C is a side view of the sensor assembly mounted on a switch blade shown in FIG. 3A;

FIG. 4A is a side view of a high voltage disconnect switch with the sensory assembly operatively attached to the switch blade;

FIG. 4B is an end view of the switch shown in FIG. 4A;

FIG. 5 is schematic diagram of the components of the sensor assembly electronics;

FIG. 6 is a schematic diagram of the components of the ground level data processing unit;

FIG. 7 is a software flowchart of the sensor assembly microcontroller; and,

FIG. 8 is a software flowchart of the ground level microcontroller.

### DETAILED DESCRIPTION OF THE INVENTION

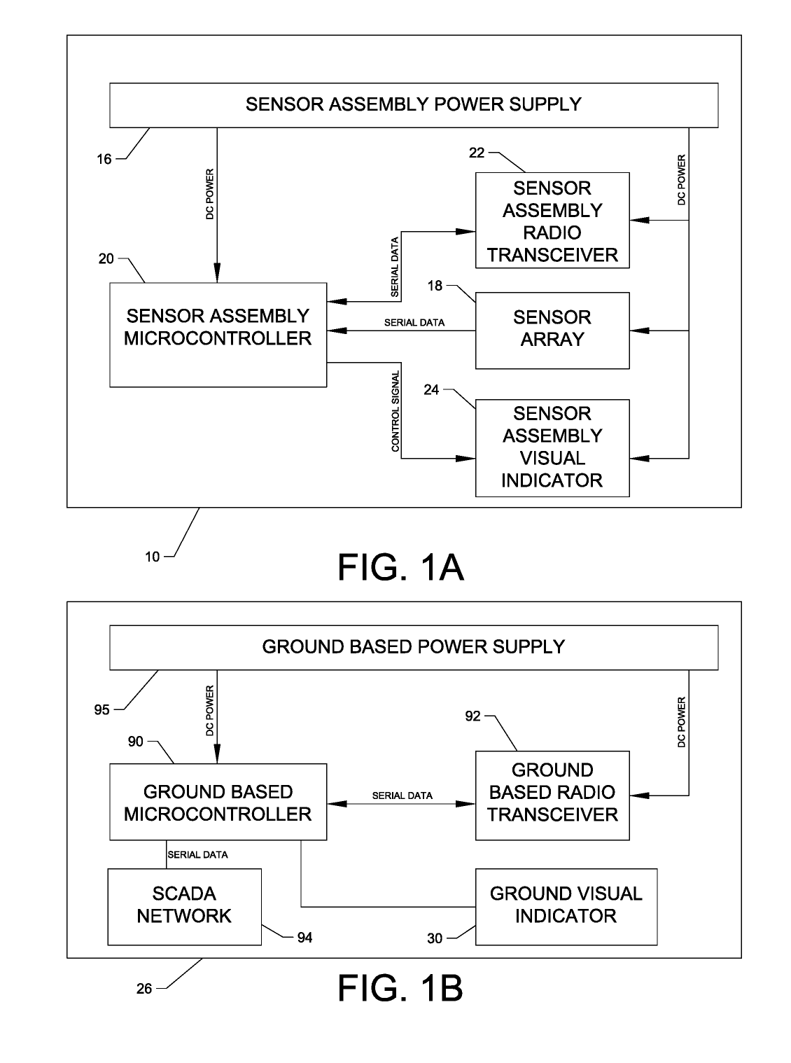

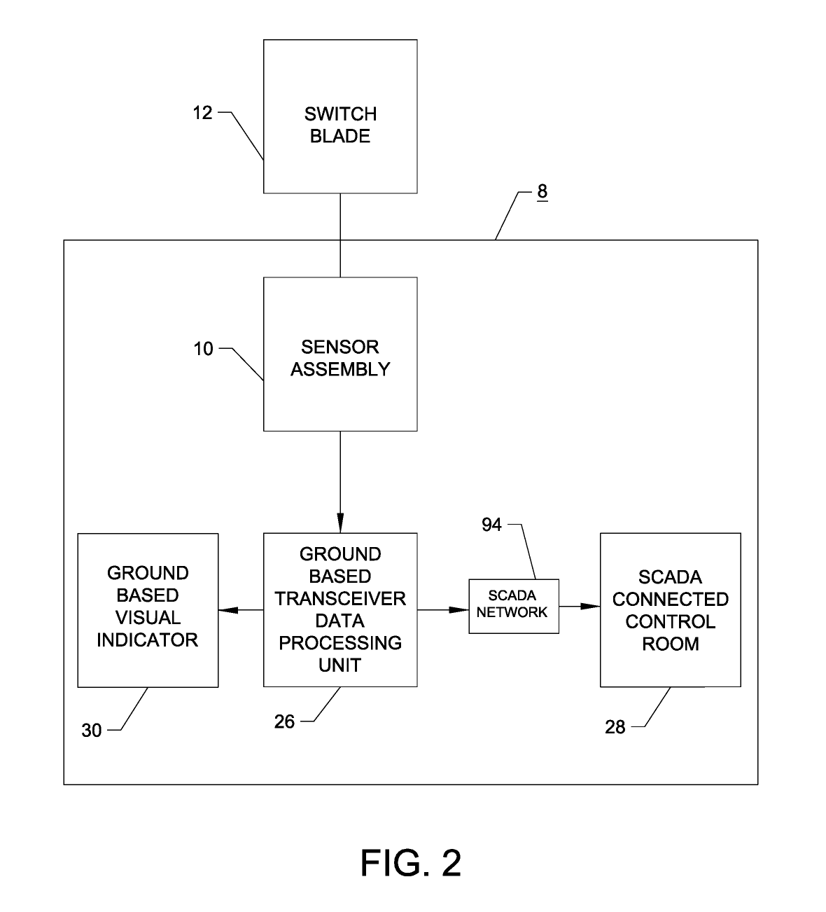

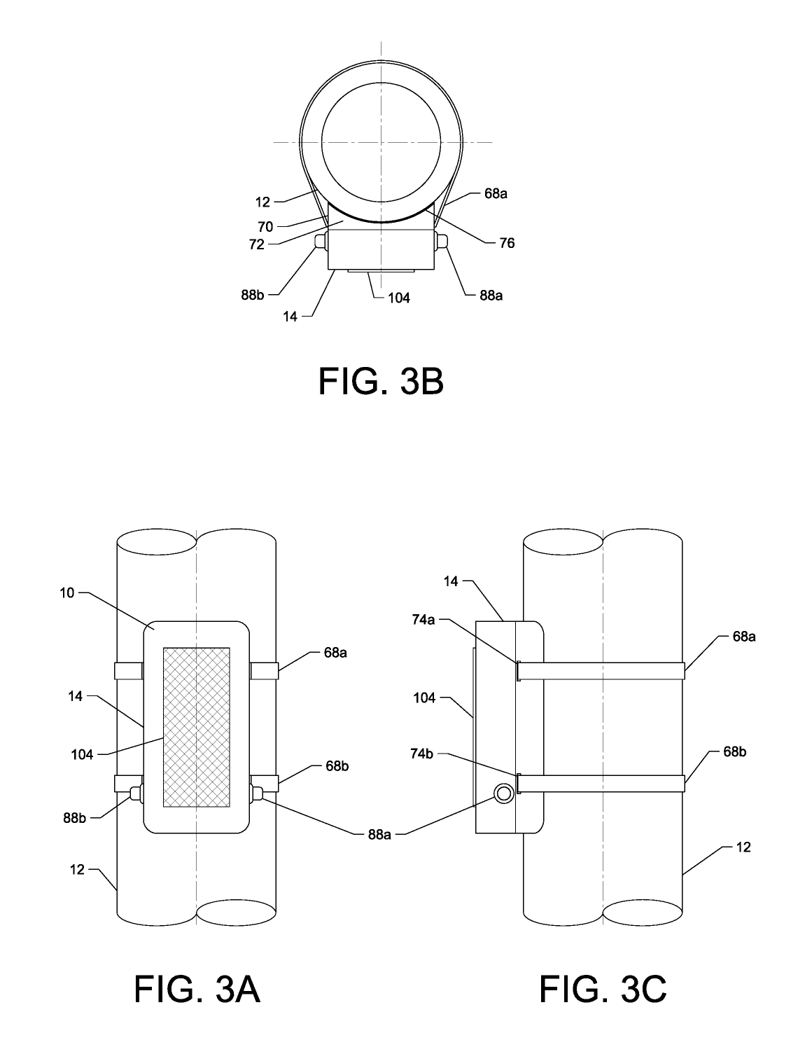

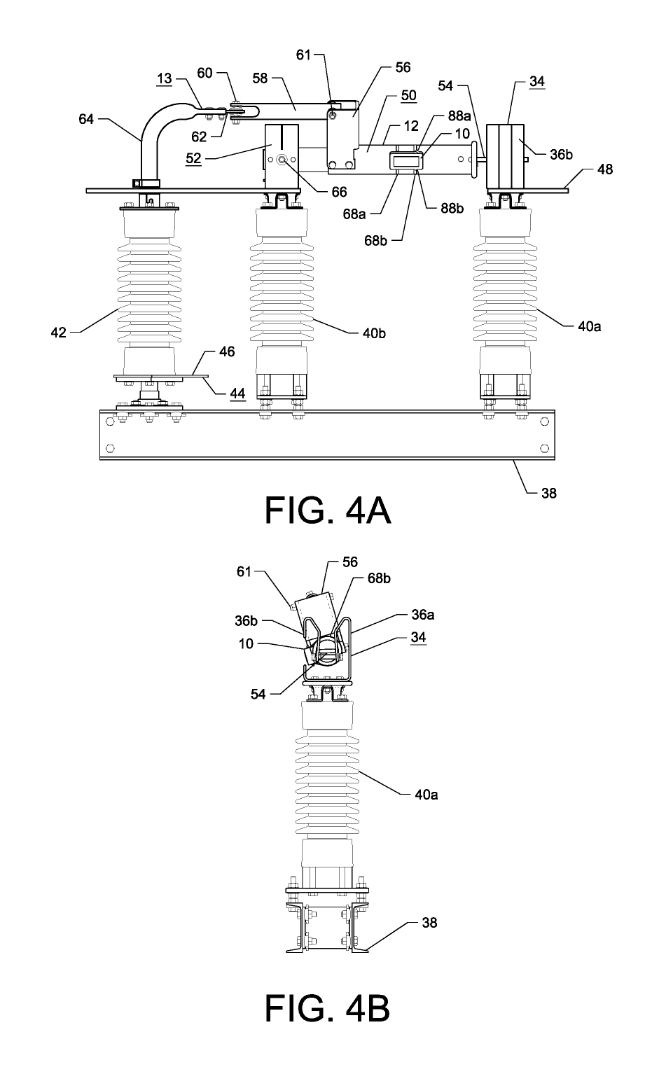

Referring to FIGS. 1A, 2, 3A, and 4A the high voltage disconnect switch blade electronic sensor assembly system 8 the present invention includes a high voltage disconnect switch blade electronic sensor assembly 10 for monitoring the position and operation of a disconnect switch blade 12 for detecting abnormal operation of a disconnect switch 13 will be described. The high voltage disconnect switch blade electronic sensor assembly 10, as shown in FIG. 3A, includes a housing 14 desirably made of plastic, such as, HDPE. In FIG. 1A the sensor assembly 10 may include a visual indicator or indication 24, which may include LED indicators 88a and 88b, for example. The sensor assembly 10 as shown in FIG. 1A also includes a power supply 16, a sensor array 18, a microcontroller 20, a radio transceiver 22 and visual indicator circuit 24. These components of the sensor assembly 10 work together to obtain the operating status of a high voltage disconnect switch 13, such as shown in FIGS. 4A and 4B, and transmit the information sensed by the sensor assembly 10 back down to a ground based radio transceiver data processing unit 26, shown in FIG. 1B and schematically in FIG. 2, which is connected to a SCADA system 28 via SCADA network 94 and ground based visual indicator 30. The ground based radio transceiver data processing unit receiver 26 has a ground based power supply 95, a ground based microcontroller 90, the ground based visual indicator 30, and ground based radio transceiver 92 as shown in FIG. 1B.

FIGS. 4A and 4B depict a horizontally mounted high voltage disconnect switch 13 which in this embodiment is depicted as the vertical break type, in the full closed position. Of course the present invention is applicable to most other types of disconnect switches, such as hookstick, center break and double end break disconnect switches, that utilize a blade that has a two or three dimensional travel path of travel. The switch 13 has a horizontal base 38. The switch 13 includes two stationary insulators 40a, 40b and a rotatable insulator 42 which are vertically mounted post-type. The first stationary post insulator 40a and the second stationary post insulator 40b are mounted as shown in FIG. 4A. The switch 13 includes a drive arrangement 44 for operating the third post insulator 42. The drive arrangement 44 may include a rotating lever handle 46 attached at the bottom of the pivoting insulator 42 for imparting rotational movement to the insulator 42. This enables the third post insulator 42 to be rotated either manually by rotating lever handle 46 or by a motor, not shown in the drawings, to cause the switch 13 to open or close as desired by rotating the switch blade 12 initially about hinge axis 66. At the top of the first post insulator 40a is attached a line-terminal connection 48 and also the stationary break-jaw contact assembly 34. The break-jaw contact assembly may be U-shaped, such as shown in FIG. 4B. Making electrical contact with the stationary break-jaw contact assembly 34, when the switch is closed, is an elongated movable switch-blade assembly 50, the latter being pivotally mounted about a hinge assembly 52. The general details of this arrangement are apparent by reference to FIG. 4A. The elongated switch-blade assembly 50, includes the elongated switch blade 12, which may be tubular, for example, which at the distal end thereof a switch blade contact portion such as a relatively flat switch blade tip 54 is attached. The flat blade tip 54 is operatively arranged for contact with oppositely disposed parting break jaw fingers 36a, 36b upon engagement with break jaw contact assembly 34 as shown in FIG. 4B.

The rotatable insulator 42, is capable of rotary operative motion for driving the switch-blade assembly 50. To mechanically interconnect the operation of the elongated movable switch-blade assembly 50 with rotation of the rotatable insulator 42, the drive arrangement 44 also includes a movable blade-arm 56 which is mounted to the horizontally extending movable switch-blade assembly 50. At the upper end of the movable blade-arm 56, is pivotally connected a link 58 by a pivot pin 61.

At pin 60 a tongue member 62 operatively engages a movable tubular crank-member 64, which is rotated by the operating motion of the rotatable insulator 42. When the rotatable insulator 42 is initially rotated when the switch is in the full-open position and now closing (not shown in the drawings), the tubular crank-member 64 causes elongated switch-blade assembly 50 to vertically pivot about the hinge axis 66 causing the blade tip 54 to initially enter the break jaw contact assembly 34; then further rotation of the rotatable insulator 42 causes the blade tip 54 to rotate about its own longitudinal axis to a final horizontal position as shown in FIGS. 4A and 4B to make full electrical contact with the break jaw fingers 36a, 36b. For further details of this switch arrangement reference is made to the previously referenced U.S. Pat. No. 9,666,393 B1 by Peter M. Kowalik, et al., issued May 30, 2017, to the present assignee, Cleaveland/Price Inc.

The horizontal vertical break disconnect switch 13 described thus far is conventional and well known in the industry. As can be seen by reference to FIGS. 3A and 3B the high voltage disconnect switch blade electronic sensor assembly 10 of the present invention may be attached to the switch blade 12 as shown via the use of a pair of clamps 68a, 68b, such as worm-drive type clamps. The back 70 of the plastic housing 14 may include a curved portion 72 having a predetermined radius which is configured to ensure a flush fit with the tubular switch blade 12 as shown in FIGS. 3A and 3B. The housing 14 includes slots 74a, 74b for receiving, respectively, clamps 68a, 68b. A thermally insulative material 76, such as fiberglass, is positioned between the housing 14 and the switch blade 12 to minimize heat transfer from a hot switch blade.

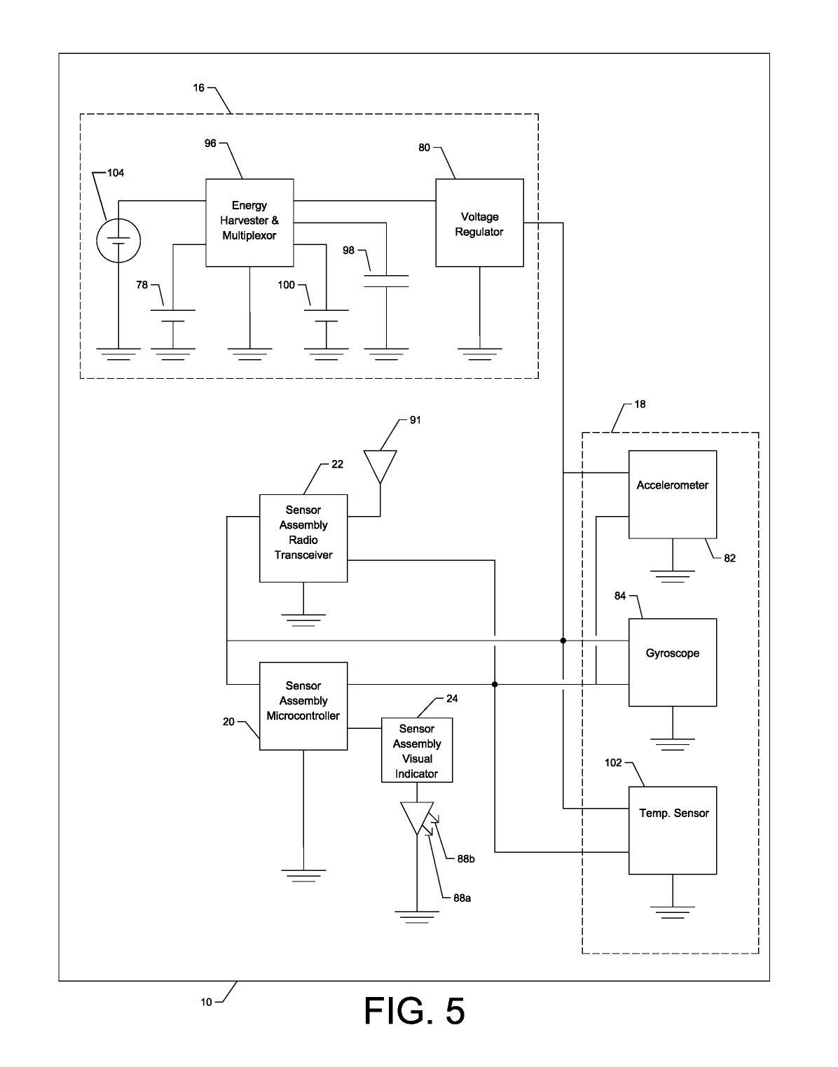

With reference to FIG. 5, the power supply 16 of the sensor assembly 10 can include a battery 78, with a an internal chemistry, such as lithium thionyl chloride for long life and the ability to withstand high temperatures. A rechargeable lithium battery 100 could be used in place of the lithium thionyl chloride battery to permit recharging by way of TI BQ2505 Energy Harvester 96 (manufactured by Texas Instruments) via solar cell 104 as shown in FIG. 3A and FIG. 5. The power supply 16 may include a voltage regulator 80 for high-efficiency voltage regulation, such as a Texas Instrument TPS6122X voltage regulator. This voltage regulator provides a stable voltage to the internal electronics of the sensor assembly 10. The sensor array 18 can be comprised of a gyroscope 84, accelerometer 82, and temperature sensor 102 for measuring the angular and rotational position and temperature of the switch blade 12. A temperature sensor 102 is of value to indicate if switch contacts 36a and 36b are overheating. FIG. 5 shows a 3-axis accelerometer 82 and 3-axis gyroscope 84 that can be built into a single component such as STMicroelectronics model LSM6D5333. A prototype has demonstrated that an accelerometer can determine the position of the switch blade. The sensor assembly microcontroller or microcontroller 20 can read the data from the 3-axis accelerometer and 3-axis gyroscope of the sensor array 18 periodically and can determine the position of the switch blade 12 in relationship to the break jaws 36a, 36b. This data is transmitted via sensor assembly antenna 91 to the ground based microcontroller 90 of the ground based radio transceiver data processing unit receiver 26 as shown in FIGS. 1A and 1B. As shown in FIGS. 1A and 3A the sensor assembly visual indicator 24 may include daylight viewable red and green LED's 88a, 88b to indicate full-open and full-closed status of the switch 13. The sensor assembly radio module 22 used with antenna 91 may be a 900 MHz transceiver used to transmit the data collected by the sensor assembly 10 to the ground based radio transceiver data processing unit 26 as shown in FIG. 2 and FIG. 5. As can be seen in FIG. 5 the battery 78 is connected in circuit with the voltage regulator 80 for powering the sensor assembly 10. The visual indicator circuit 24 of FIG. 1A includes status LED's, i.e., light emitting diodes 88a and 88b, that provide a visual indication of the status of switch blade 12 operation to indicate proper and abnormal operation. FIG. 5 shows visual indicator 24 circuit with visual indicators 88a and 88b.

The operation of the sensor assembly 10 as shown in FIG. 5 is now explained. The sensor assembly 10 determines if the switch 13 is operating within desired specifications. If the switch 13 is not working properly, including not closing properly, the sensor assembly 10 will alert a utility operator, either visually or by transmitting of data back to a central communications network. The sensor assembly 10 attaches directly to the blade 12 of the switch 13. It monitors blade position, speed, and/or acceleration to determine if there are any issues with the switch's operation. It also preferably monitors blade temperature. Additionally, the switch assembly 10 insures that the switch 13 is properly seated into its pressure contacts, i.e., jaw fingers 36a, 36b. Initially upon installation on the blade 12 a ground-based transceiver 26 issues to the sensor assembly 10 a calibrate command and the switch 13 is “calibrated” several times, by logging the initial acceptable switch blade 12 position, speed, temperature, and acceleration characteristics for the switch 13. After which an “end calibrate” message is sent from the ground-based transceiver. From this point, the sensor assembly 10 compares the operational characteristics to the initial calibration; this indicates proper switch functionality. The average open position, travel time, and closed position is then saved to the internal memory of the sensor assembly microcontroller 20.

With reference to FIG. 5 the initial calibration of the sensor assembly 10 takes place as follows: The sensor assembly radio 22 receives a command to begin calibration from a ground based transceiver 26. The switch 13 is then properly opened and closed several times. The gyroscope 84 and accelerometer 82 monitors the position, angular velocity and acceleration of the switch. The sensor assembly microcontroller 20 records the switch proper operations. The ground based transceiver 26 sends a command to end calibration to the sensor assembly 10.

Once the initial calibration is complete the sensor assembly 10 monitors the operational characteristics of the switch 13 as follows:

The sensor assembly 10 determines if the switch 13 is moving at the expected velocity, and ensures that the switch blade 12 is properly seated into its pressure contacts, i.e., jaw fingers 36a, 36b. Improper or unexpected switch 13 movement can indicate excessive wear and tear on the equipment. Additionally, if a switch blade 12 is not properly seated into its pressure contacts upon switch energization, the switch contacts can be damaged, degrading the ampacity of the switch 13.

The sensor assembly power supply 16 keeps the sensor assembly 10 online. Instead of just a non-rechargeable battery 78 or a rechargeable battery 100, it could be powered by a solar panel, thermoelectric generator, an inductive power supply,—or some combination of them. The sensor assembly power supply 16 powers the entire sensor assembly 10, including sensor assembly microcontroller 20, sensor assembly visual indicator 24, and sensor assembly radio module 22. A sensor assembly power supply management system can be included in the sensor assembly microcontroller 20 to incorporate, manage, and charge various energy storage devices such as sensor assembly batteries 100 and capacitors 98.

The sensor array 18 may be comprised of many types of sensors to determine position, speed, angle or distance of the switch blade 12 relative to the break jaws or fingers 36a, 36b, for example. Examples of such sensors, include gyroscopes, magnetometers, accelerometers, ultrasonic transducers, time-of-flight light sensors, such as LIDAR, or cameras. The sensor assembly microcontroller 20, in one embodiment, can process the data from the sensors and communicates with the ground data processing device 26. The sensor assembly visual indicator 24 is optional, but if used, could be an onboard visual indicator, or a remote indication transmitted via wire or through a wireless communication device. The sensor assembly microcontroller 20 can manage the sensor assembly power supply 16, the sensor array 18, the sensor assembly radio module 22 and the sensor assembly visual indicator 24. Depending on the function of the sensor assembly 10, and the amount of data that is obtained from it, the ground data processing unit 26 may include the ground based microcontroller 90, such as shown in FIG. 1B. The ground data processing unit 26 also includes the second radio transceiver 92 for communicating with the sensor assembly radio transceiver 22 and optionally with a communications SCADA network 94 that is connected to a control room 28, as shown in FIG. 2. The ground based data processing unit 26 can reduce the power and computational requirements of the sensor assembly 10, and aggregate sensor readings to diagnose trends. The ground based data processing unit 26 can serve to improve the reference data and operational characteristics among a population of switches 13. Thus, by use of the ground based data processing unit 26 it can indicate system health and operating parameters of several switches. The ground based data processing unit 26 may be connected to a ground based visual indicator 30 as shown in FIG. 2. The ground based visual indicator 30 functions as follows: the ground based visual indicator 30 will illuminate when there is switch blade movement that is outside the tolerance of a calibrated operation.

A current sensor, not shown in the drawings, can be provided, magnetically coupled to the switch 13 or otherwise, to determine if current is flowing through the switch 13. Clamps 68a and 68b can be replaced or combined with a split-core direct current sensor or Rogowski coil to measure switch blade 12 currents and transmit values to the sensor assembly radio transceiver 22. A calibration method for the sensor assembly 10, incorporating a push-button, radio command, or other external signal to the sensor assembly 10 can be used for calibration and set up. A sensor to monitor environmental information, such as humidity and/or barometric pressure could be provided.

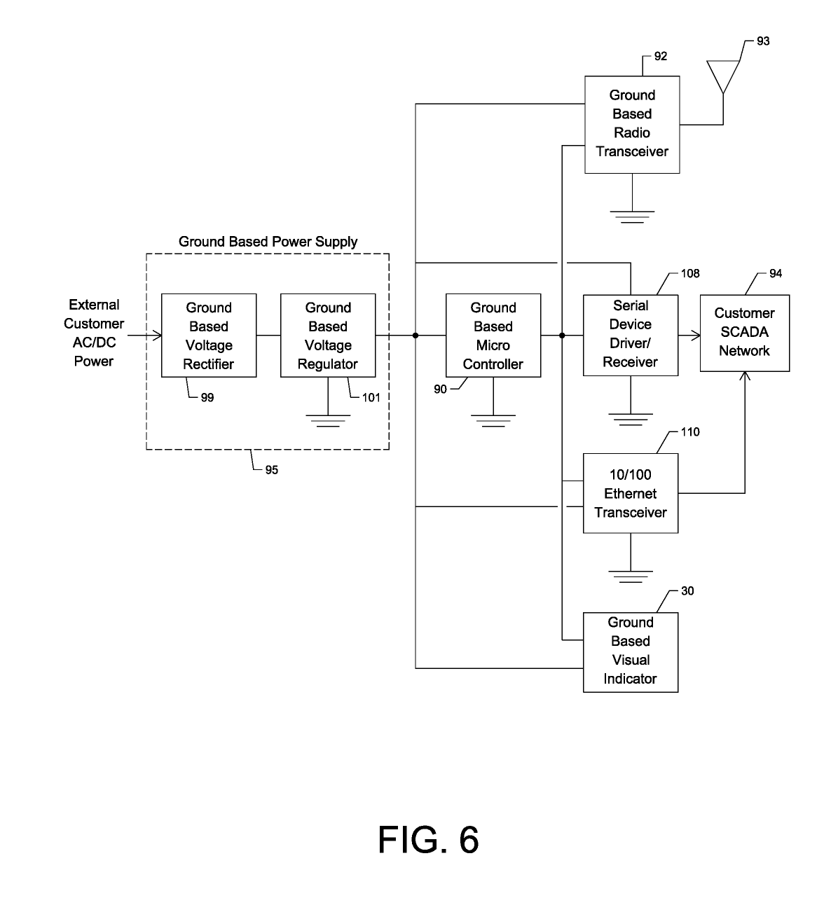

With reference to FIG. 6, the ground based power supply 95 draws power from the customer's AC or DC power supply. This power is rectified by ground based voltage rectifier 99 and efficiently regulated by ground based voltage regulator 101 to a level that is required by the internal electronics shown in FIG. 1B and FIG. 6. The ground based microcontroller 90 uses the ground based radio transceiver 92 for communication via ground based antenna 93 with the sensor assembly antenna 91 and sensor assembly radio transceiver 22 shown in FIG. 5. The data received from the sensor assembly is aggregated and may be shown locally with a daylight viewable LED ground based visual indicator 30. An alternate method that may be used is for the ground based microcontroller 90 to provide information to the customer's SCADA network 94. This network may be operated via serial communication which the microcontroller provides with the serial device driver/receiver 108 or the SCADA network may require IP, i.e., internet protocol, based communication which the ground based microcontroller 90 provides with the 10/100 Ethernet transceiver 110. Both of these SCADA interfaces can access the ground based microcontroller 90 and query a variety of data received from the sensor assembly 10. This data may include positional data provided by the gyroscope 84 and accelerometer 82 and/or switch blade temperature provided by the temperature sensor 102 all shown in FIG. 5.

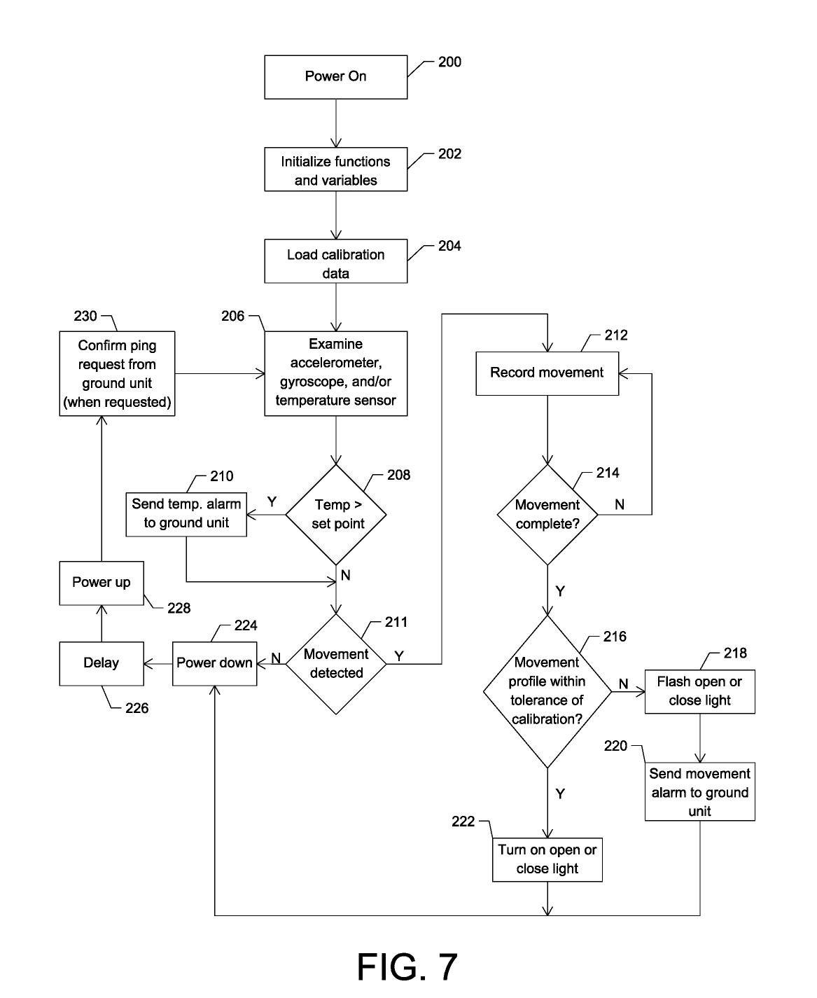

With reference to FIG. 7, the flowchart details the operation of the firmware present in the sensor assembly microcontroller 20 shown in FIG. 1A and FIG. 5. Upon power on at step 200, the firmware will initialize all functions at step 202 and load calibration data at step 204 from non-volatile memory present within the microcontroller. The sensor assembly microcontroller 20 begins the scanning process where it examines the data from the accelerometer, gyroscope, and temperature sensors at step 206. If the blade temperature sensed exceeds the set point at step 208, which is contained as part of the calibration data at step 204, an alarm message is sent to optional ground based transceiver data processing unit 26 for reporting through the SCADA network if available. If movement of switch blade 12 is detected from the accelerometer 82 or gyroscope 84 at step 211, the blade movement is recorded at step 212 until completion of blade movement and compared against calibration data within a specified tolerance at step 216. If this blade movement is found to be within tolerance, a daylight visible open or close light is illuminated at step 222 by activating the ground based visual indicator 30 and/or the sensor assembly visual indicator 24 to indicate that a successful operation has occurred. If the blade movement is found to be out of tolerance, a daylight visible open or close light is flashed at step 218 by activating the ground based visual indicator 30 and/or the sensor assembly visual indicator 24 and a message is sent to the ground based transceiver data processing unit 26 at step 220 for local and SCADA indication that there is an issue with the operation of the switch blade 12. If no movement of the switch blade 12 has been detected or if movement has been detected and has been acted upon, the sensor assembly 10 will power down at step 224 to conserve power. After a delay at step 226, the unit will power on to confirm a ping request from the optional ground based transceiver data processing unit 26 at step 230 and to return to the start of the accelerometer, gyroscope, and temperature sensor scanning process at step 206. This process is repeated continuously.

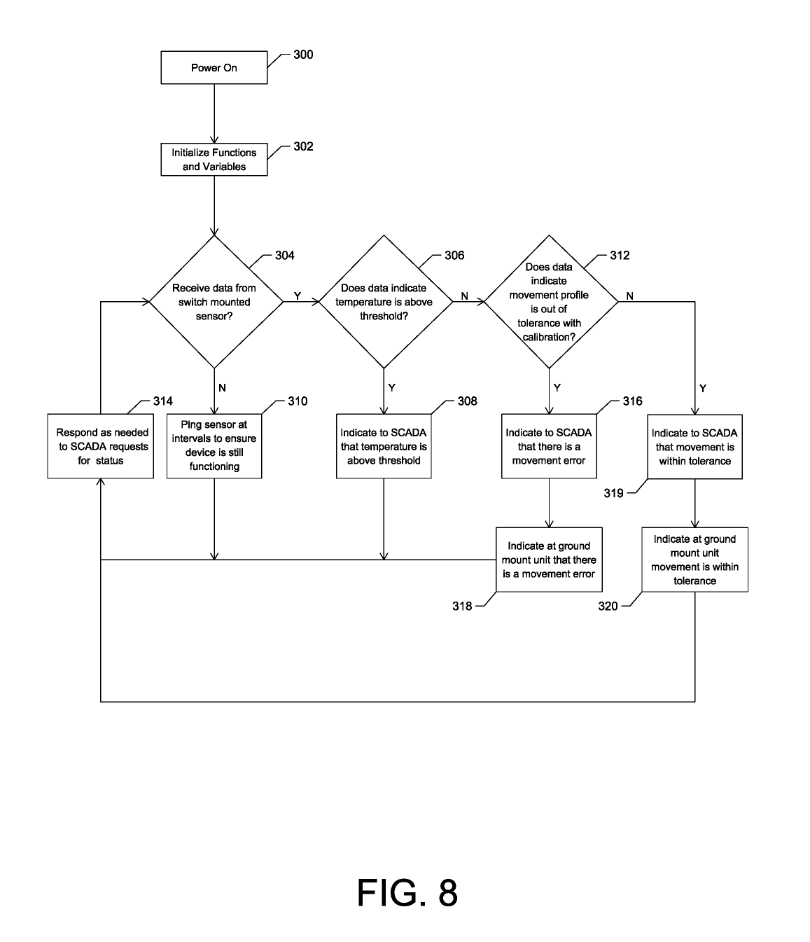

With reference to FIG. 8, the flowchart details the operation of the firmware present in the ground level data processing unit microcontroller 90 shown in FIG. 1B and FIG. 6. Upon power on at step 300, the firmware will initialize all functions at step 302 and then wait for data to be transmitted by the sensor assembly 10 shown in FIG. 1A and FIG. 5. If no data is received at step 304 from the sensor assembly 10, the ground level transceiver data processing unit 26 will send ping messages to the sensor assembly 10 at step 310 to ensure that is still functional. If data is received from the sensor assembly 10, it is first analyzed to determine if the message contains switch blade temperature information at step 306. If the message does indicate that the switch blade temperature is above the threshold level, the ground based transceiver data processing unit 26 will alarm the SCADA network of this over temperature at step 308. If the message does not contain temperature information, the message then is checked for blade movement profile being outside of tolerance at step 312. If the blade movement profile is detected as being outside of tolerance, the ground based transceiver data processing unit 26 will indicate to SCADA of this situation at step 316 and indicate locally via daylight visible LED's at step 318. If the blade movement is within tolerance of calibration, the ground based transceiver data processing unit 26 will indicate to SCADA of the proper operation at step 319 and indicate locally via daylight visible LED's at step 320. During any of the loop branches, the ground based transceiver data processing unit 26 will respond to any SCADA requests for status at step 314 either when requested for status or by exception.

Of course variations from the foregoing embodiments are possible without departing from the scope of the invention.

What is claimed is:

1. A disconnect switch blade electronic sensor assembly system for a disconnect switch, the disconnect switch including a switch blade in operative arrangement with a disconnect switch stationary contact assembly having oppositely disposed stationary contacts, the switch blade pivotable at a proximal end thereof and having a switch blade contact portion at a distal end thereof in full electrical and mechanical contact relationship with the oppositely disposed stationary contacts in a switch fully closed position and the switch blade contact portion out of electrical and mechanical contact with the oppositely disposed stationary contacts in a switch fully open position, the disconnect switch blade electronic sensor assembly system including a sensory assembly comprising:
a housing attached directly to and carried by the pivotable switch blade, a self-contained sensor array mounted within the housing in operative arrangement with the pivotable switch blade, the self-contained sensor array including means for electronically detecting and measuring at least one of position, velocity, and acceleration of the pivotable switch blade for detecting proper switch functionality, including ensuring that the switch blade contact portion is properly positioned in relationship with the stationary contact assembly in the switch fully closed position and ensuring that the pivotable switch blade is completely disengaged from the stationary contact assembly in the switch fully open position.

2. The disconnect switch blade electronic sensor assembly system of claim 1, further including a sensor assembly power supply in operative electrical circuit arrangement with the self-contained sensor array.

3. The disconnect switch blade sensor electronic assembly system of claim 2, further including a sensor assembly microcontroller in operative electrical circuit arrangement with the sensor assembly power supply and the self-contained sensor array.

4. The disconnect switch blade sensor electronic assembly system of claim 3, further comprising a sensor assembly radio transmitter or transceiver in operative communication arrangement with a receiver or transceiver at ground level for communicating electronic measurements to a control room receiver.

5. The disconnect switch blade electronic sensor assembly system of claim 1, wherein the means for electronically measuring at least one of position, velocity, and acceleration of the pivotable switch blade includes an accelerometer.

6. The disconnect switch blade electronic sensor assembly system of claim 1, wherein the means for measuring at least one of position, velocity, and acceleration of the switch blade includes a gyroscope.

7. The disconnect switch blade electronic sensor assembly system of claim 4, further comprising a ground based data processing unit in radio communication with the sensor assembly radio transmitter or transceiver and the sensor assembly microcontroller.

8. The disconnect switch blade electronic sensor system assembly of claim 1, wherein the housing comprises plastic or metal.

9. The disconnect switch blade electronic sensor assembly system of claim 8, wherein the housing includes a back portion having a recess configured to form a flush fit with the pivotable switch blade in the operative position.

10. The disconnect switch blade electronic sensor assembly system of claim 9, wherein the housing has slots therethrough in predetermined position for receiving clamps in operative attachment with the pivotable switch blade.

11. The disconnect switch blade electronic sensor assembly system of claim 9, further including an insulating member in operative position between the housing and the switch blade.

12. The disconnect switch blade electronic sensor assembly system of claim 2, wherein the sensor assembly power supply includes a battery.

13. The disconnect switch blade electronic sensor assembly system of claim 12, wherein the battery is solar charged.

14. The disconnect switch blade electronic sensor assembly system of claim 3, further including a sensor assembly visual indicator of proper switch operation in operative electrical circuit arrangement with the sensor assembly microcontroller.

15. The disconnect switch blade electronic sensor assembly system of claim 14, wherein the sensor assembly visual indicator includes light emitting diodes mounted in predetermined position on the housing for visual indication of the fully closed position and the fully open position of the high voltage disconnect switch.

16. The disconnect switch blade electronic sensor assembly system of claim 1, wherein the sensor assembly further comprising a switch blade temperature sensor.

17. The disconnect switch blade electronic sensor assembly system of claim 1, wherein the sensor assembly further comprises a calibration device.

18. The disconnect switch blade electronic sensor assembly system of claim 1, wherein the sensor assembly further comprises a switch blade current sensor.

19. The disconnect switch blade electronic sensor assembly system of claim 7, wherein the ground based data processing unit further comprises a ground based transceiver in operative communication arrangement with the sensor assembly transceiver.

20. The disconnect switch blade electronic sensor assembly system of claim 19, wherein the ground based data processing unit further comprises a ground based data processing microcontroller in operative arrangement with the ground based transceiver.

21. A disconnect switch comprising:
a switch blade in operative arrangement with a disconnect switch stationary contact assembly, the switch blade pivotable proximate a proximal end thereof and having a switch blade contact portion at a distal end thereof in full electrical contact relationship with oppositely disposed stationary contacts of the disconnect switch stationary contact assembly in a switch fully closed position and the switch blade contact portion out of electrical contact with the oppositely disposed stationary contacts of the disconnect switch stationary contact assembly in a switch fully open position;
a disconnect switch blade electronic sensor assembly system including, a housing attached directly to the switch blade in predetermined position, a self-contained sensor array in operative arrangement within the housing, and, means for electronically detecting and measuring at least one of switch blade position, angular velocity, and acceleration of the switch blade for detecting proper switch functionality, including during closing and opening of the disconnect switch for ensuring that the switch blade contact portion is properly positioned in relationship with the oppositely disposed stationary contacts of the disconnect switch stationary contact assembly in the fully closed position and ensuring that the switch blade is completely disengaged from the oppositely disposed stationary contacts of the disconnect switch stationary contact assembly in the switch fully open position.

22. The disconnect switch of claim 21, further including a sensor assembly power supply in operative electrical circuit arrangement with the sensor array.

23. The disconnect switch of claim 22, further including a sensor assembly microcontroller in operative electrical circuit arrangement with the sensor assembly power supply and the self-contained sensor array.

24. The disconnect switch of claim 23, further comprising a sensor assembly radio transceiver in operative communication arrangement with at least one of a ground based transceiver and a communications network and a control room transceiver.

25. The disconnect switch of claim 24, further comprising a ground based data processing microcontroller in operative arrangement with the sensor assembly radio transceiver and sensor assembly microcontroller.

26. The disconnect switch of claim 21, wherein the housing comprises plastic or metal.

27. The disconnect switch of claim 26, wherein the housing includes a back portion having a recess configured to form a flush fit with the switch blade in the operative position.

28. The disconnect switch of claim 27, wherein the housing has slots therethrough in predetermined position for receiving clamps in operative attachment with the switch blade.

29. The disconnect switch of claim 26, further including an insulating member in operative position between the housing and the switch blade.

30. The disconnect switch of claim 22, wherein the power supply includes a battery.

31. The disconnect switch of claim 30, where in the battery is solar charged.

32. The disconnect switch of claim 23, further including a sensor assembly visual indicator in operative electrical circuit arrangement with the sensor assembly microcontroller.

33. The disconnect switch of claim 32, wherein the visual sensor assembly indicator includes light emitting diodes mounted in predetermined position on the housing for visual indication of the fully closed position and the fully open position of the disconnect switch.

34. The disconnect switch of claim 21, wherein the means for measuring at least one of position, angular velocity, and acceleration of the switch blade includes an accelerometer.

35. The disconnect switch of claim 21, wherein the means for measuring at least one of position, angular velocity, and acceleration of the switch blade includes a gyroscope.

36. The disconnect switch of claim 22, wherein the sensor assembly further comprises a switch blade temperature sensor.

37. The disconnect switch of claim 21, wherein the sensor assembly further comprises a calibration device.

38. The disconnect switch of claim 21, wherein the sensor assembly further comprises a switch blade current sensor.

39. The disconnect switch of claim 25, wherein the ground based data processing microcontroller further comprises a ground based data transceiver in operative communication arrangement with the sensor assembly transceiver.

40. The disconnect switch of claim 39, wherein the ground based data processing microcontroller is in operative arrangement with the ground based data transceiver.

41. A method for detecting proper operation of a disconnect switch, the disconnect switch including a switch blade in operative arrangement with a disconnect switch stationary contact assembly having oppositely disposed stationary contacts, the switch blade pivotable at a proximal end thereof and having a switch blade contact portion at a distal end thereof in full electrical and mechanical contact relationship with the oppositely disposed stationary contacts of the disconnect switch stationary contact assembly in a switch fully closed position and the switch blade contact portion out of electrical and mechanical contact with the oppositely disposed stationary contacts of disconnect switch stationary contact assembly in a switch fully open position, a disconnect switch blade sensor assembly including an electronic sensor assembly having a housing attached directly to the switch blade in predetermined position, the sensor assembly including a self-contained sensor array in operative arrangement within the housing, the self-contained sensor array including means for electronically detecting and measuring at least one of acceleration, angular velocity, and position of the switch blade for detecting proper switch functionality, including during closing and opening of the disconnect switch for ensuring that the switch blade contact portion is properly positioned in the disconnect switch stationary contact assembly in the switch fully closed position and for ensuring that the switch blade is completely disengaged from the disconnect switch stationary contact assembly in the switch fully open position, said method comprising the following steps:
the sensor assembly monitors at least one of the acceleration, position and velocity of the switch blade and compares it to previously recorded acceleration, position and/or velocity measurements known to be within acceptable limits for the disconnect switch,
if the position, acceleration and/or velocity of the switch is detected either not within or within the previously recorded acceleration, position and/or velocity acceptable limits for the disconnect switch, the electronic sensor assembly initiates indication that the switch is operating either improperly not within the previously recorded acceleration, position and/or velocity acceptable limits for the disconnect switch or properly within the previously recorded acceleration, position and/or velocity acceptable limits for the disconnect switch and transmits the information via a radio to a utility control room radio.
